(19) United States
(12) Patent Application Publication
(10) Pub. No.: US 2005/0043064 A1
(43) Pub. Date: Feb. 24, 2005

(54) SYSTEM AND METHOD FOR DISPLAYING DATA WITH A MOBILE PHONE

(76) Inventor: Jui-Hsiang Lo, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,834

(22) Filed: Oct. 30, 2003

(30) Foreign Application Priority Data
Aug. 18, 2003 (TW) 092122663

(51) Int. Cl. H04B 1/38

(52) U.S. Cl. 455/566; 455/556.1

(57) ABSTRACT

A system for displaying data with a mobile phone on a display device comprises an image transferring apparatus for connecting to computer and mobile phone, the image transferring apparatus-comprising a housing, a receiving module inside the housing for receiving data from the computer, a memory inside the housing for storing data from the computer, a control module for controlling the image transferring apparatus, and an outputting module for outputting data to the mobile phone. It comprises a video transferring apparatus for connecting to the mobile phone and the display device. The video transferring apparatus comprising a receiving module for receiving data from the mobile phone, a control module for controlling the video transferring apparatus, a transferring module for transferring data from the receiving module of the video transferring apparatus into video signals, and an outputting module for outputting video signals transferred by the transferring module to the display device.

### BACKGROUND OF INVENTION

1. Field of the Invention

The present invention relates to a system, and more specifically, to a system for displaying data with a mobile phone.

2. Description of the Prior Art

Now a days meetings between companies are held very often. Most business people use notebooks to make presentations at meetings, for example when visiting clients. The report content and the business material can be stored in a notebook, which can be carried to the client company. Notebooks can be connected to a display device, for example a projector for displaying the report content. Notebooks have become mature and powerful but it is not convenient for users to carry a heavy and big computer apparatus with them all the time. In addition, due to the complex operating system of portable computers, the booting period is too long to allow briefing clients rapidly.

In conclusion, business people or researchers are not able to brief clients rapidly with a conventional portable computer apparatus. Thus, there is a need to design a displaying system, which is convenient to carry around and can be used for rapid briefings.

### SUMMARY OF INVENTION

It is therefore a primary objective of the present invention to provide a system for displaying data with a mobile phone to solve the problems mentioned above.

Briefly summarized, a system for displaying data with a mobile phone on a display device comprises an image transferring apparatus for connecting to a computer and the mobile phone, the image transferring apparatus comprising a housing, a receiving module installed inside the housing for receiving data from the computer, a memory installed inside the housing for storing data from the computer, a control module for controlling the image transferring apparatus, and an outputting module for outputting data to the mobile phone. The system further comprises a video transferring apparatus for connecting to the mobile phone and the display device, the video transferring apparatus comprising a receiving module for receiving data from the mobile phone, a control module for controlling the video transferring apparatus, a transferring module for transferring data from the receiving module of the video transferring apparatus into a video signal, and an outputting module for outputting the video signal transferred by the transferring module to the display device.

Briefly summarized, a method for displaying data with a mobile phone comprises: (a) providing an image transferring apparatus for receiving data; (b) transmitting data received by the image transferring apparatus to the mobile phone; (c) providing a video transferring apparatus for receiving data from the mobile phone and transferring data from the mobile phone to a video signal; and (d) transmitting the video signal transferred by the video transferring apparatus to a display device and showing the data on the display device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram drawing of a display system according to the present invention.

FIG. 2 is a block diagram of an image transferring apparatus.

FIG. 3 is a block diagram of a video transferring apparatus.

FIG. 4 contains a flowchart illustrating the display of the display system to the present invention.

### DETAILED DESCRIPTION

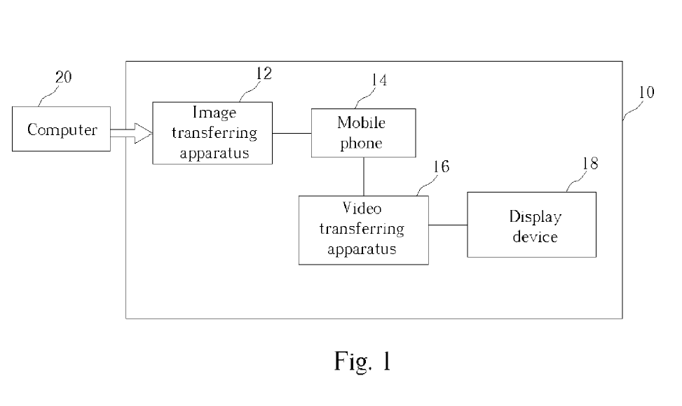

Please refer to FIG. 1. FIG. 1 is a block diagram drawing of a display system 10 according to the present invention. The display system 10 includes an image transferring apparatus 12, a mobile phone 14, a video transferring apparatus 16, and a display device. The image transferring apparatus is connected to a computer 20 and the mobile phone. The mobile phone 14 is connected to the image transferring apparatus 12 and the video transferring apparatus 16. The display device is connected to the video transferring apparatus 16.

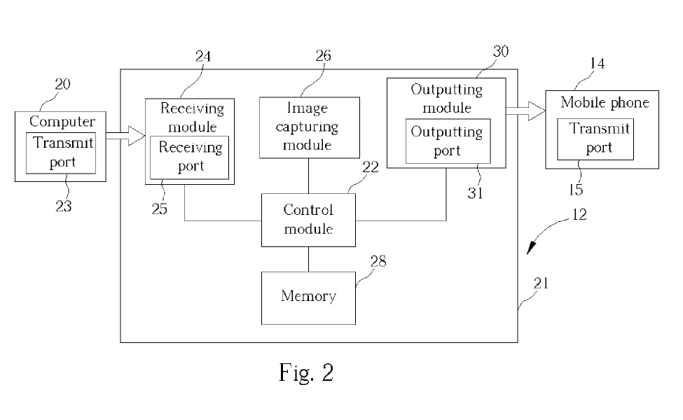

Please refer to FIG. 2. FIG. 2 is a block diagram of the image transferring apparatus 12. The image apparatus includes a housing 21, a control module 22 installed inside the housing 21 for controlling the image transferring apparatus 12, a receiving module 24 installed inside the housing 21 and connected to the control module 22 for receiving data from the computer 20, and an image capturing module 26, which has an image sensor including a plurality of charge coupled devices (CCD) or a plurality of complementary metal-oxide semiconductor (CMOS), electrically connected to the control module 22 of the image transferring apparatus 12 for capturing an image. The image capturing module 26 can be a digital camera for capturing digital images to the image transferring apparatus 12. The image transferring apparatus 12 further includes a memory 28 installed inside the housing 21 for storing data from the computer 20 or image data captured by the image capturing module 26, and an outputting module 30 installed inside the housing 21 for outputting data to the mobile phone 14. The receiving module 24 of the image transferring apparatus 12 includes a receiving port 25 for connecting to a transmit port 23 of the computer 20 and transmitting data to the transmit port 23 of the computer 20. The receiving port can be USB or have another interface and the connection between the receiving port 25 and the transmit port 23 of the computer 20 can be any type of connector. And the data communication between the receiving port 25 and the transmit port 23 of the computer 20 can be established by a cable or in a wireless method. The outputting module 30 of the image transferring apparatus 12 includes an outputting port 31 for connecting to a transmit port 15 of the mobile phone 14 and transmitting data to the transmit port 15 of the mobile phone 14. The outputting port 31 can be USB OTG, pop-port, or other interfaces and the connection between the outputting port 31 and the transmit port 15 of the mobile phone 14 can be any type of connector. And the data communication between the outputting port 31 and the transmit port 15 of the mobile phone 14 can be made by a cable or in a wireless method.

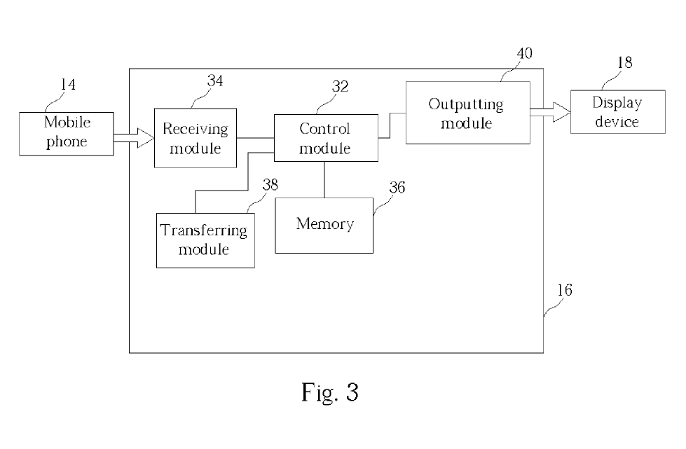

Please refer to FIG. 3. FIG. 3 is a block diagram of the video transferring apparatus 16. The video transferring apparatus 16 includes a control module 32 for controlling the video transferring apparatus 16, a receiving module 34 connected to the control module 32 for receiving data from the mobile phone 14, a memory 36 for storing data received by the receiving module 34 of the video transferring apparatus 16, a transferring module 38 for transferring data from the receiving module 34 of the video transferring apparatus 16 into a video signal, and an outputting module 40 for outputting the video signal transferred by the transferring module 38 to the display device 18.

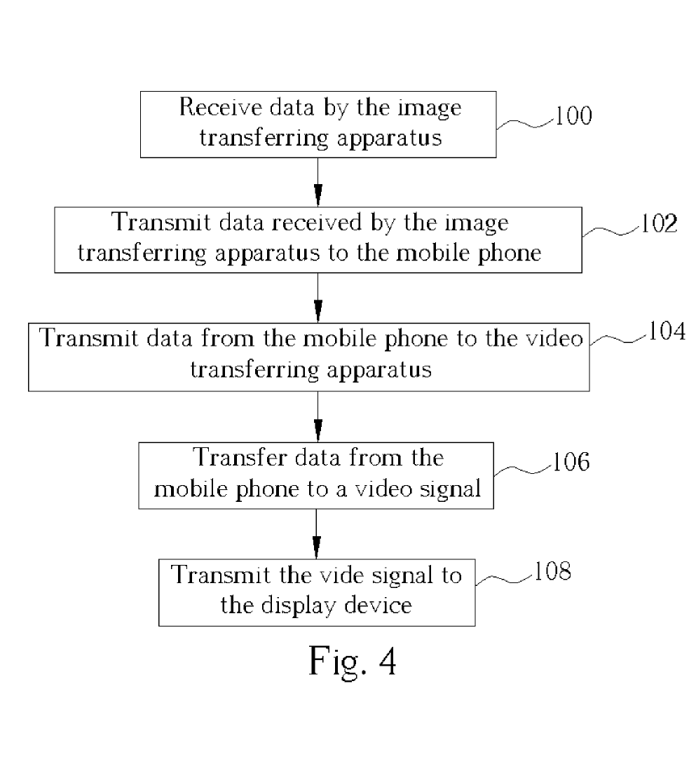

Please refer to FIG. 4. FIG. 4 contains a flowchart illustrating the display of the display system 10 to the present invention. The method includes:

Step 100: receive data by using the image transferring apparatus 12;

Step 102: transmit data received by the image transferring apparatus 12 to the mobile phone 14;

Step 104: transmit data received from the image transferring apparatus 12 from the mobile phone 14 to the video transferring apparatus 16;

Step 106: transfer data from the mobile phone 14 to a video signal; and

Step 108: transmit the video signal transferred by the video transferring apparatus 16 to the display device 18 and show the data on the display device 18.

The detail description is as follows, for example, as shown in FIG. 2 if a report like an image file or other type files is stored in the computer 20 such as a desktop computer or a notebook, the user can transmit the report from the computer 20 to the image transferring apparatus 12. The receiving module 24 of the image transferring apparatus 12 can receive the report by the receiving port 25 from the transmit port 23 of the computer 20. The control module 22 of the image transferring apparatus 12 can store the report received by the receiving module 24 in the memory 28 or transmit the report or the stored data in the memory 28 to the outputting module 30 of the image transferring apparatus 12. The outputting module 30 can output the report from the control module 22 to the transmit port 15 of the mobile phone 14 by the outputting port 31. The outputting module 30 of the image transferring apparatus 12 can transmit data to the mobile phone 14 using Bluetooth wireless network protocol or by infrared technology. In addition the outputting port 31 can be a pop-port interface or USB OTG interface and so on. Besides receiving the report by the receiving module 24 of the image transferring apparatus 12 from the computer 20, the image capturing module 26 can capture an image and the control module 22 of the image transferring apparatus 12 can store the image captured by the image capturing module 26 in the memory 28 or transmit the image to the outputting module 30 of the image transferring apparatus 12 and output the image to the mobile phone 14 by the outputting module 30.

After the image transferring apparatus 12 receives the report from the computer 20, the image transferring apparatus 12 can be removed from the computer 20, or the receiving port 25 of the image transferring apparatus 12 and the transmit port 23 of the computer 20 are disconnected. And then the image transferring apparatus 12 can be carried to the meeting place and connected to the mobile phone 14 for transmitting the report to the mobile phone 14.

Users also can transmit the report from the computer 20 to the mobile phone 14 via the image transferring apparatus 12 and only carry the mobile phone 14 to the meeting place for presentation. After the mobile phone 14 receives the report from the outputting module 30 of the image transferring apparatus 12, the report can be edited or arranged on the mobile phone 14 and then transmitted to the video transferring apparatus 16. So the mobile phone can be a remote control device. As shown in FIG. 3, the receiving module 34 of the video transferring apparatus 16 can receive the report from the mobile phone 14 in a wire or wireless manner. The control module 32 of the video transferring apparatus 16 can store the report received by the receiving module 34 in the memory 36 and then read the report from the memory 36 to the transferring module 38 for transferring the report into a corresponding video signal. And then the control module 32 of the video transferring apparatus 16 can transmit the corresponding video signal transferred by the transferring module 38 to the display device 18 and show the report on the display device 18. The display device 18 can be a television, a monitor, or a projector, and so on.

In contrast to the prior art, the present invention provides the mobile phone 14 with the data presentation and not the notebook. The mobile phone is a conveniently carried and popular device and capable of presenting reports rapidly. The present invention is a useful design for mobile phones and the present function may also benefit the sale of mobile phones. Furthermore the report can be sent to each participant by the MMS function of the mobile phone instead of storing the report in a storing media or sending the report by e-mail. In conclusion the present invention provides a system, which can be conveniently carried, rapidly present data, and easily transmit data.

Those skilled in the art will readily observe that numerous modifications and alterations of the device may be made while retaining the teachings of the invention. Accordingly, the above disclosure should be construed as limited only by the metes and bounds of the appended claims.

1. A system for displaying data with a mobile phone on a display device comprising:
an image transferring apparatus for connecting to a computer and the mobile phone comprising:
a housing;
a receiving module installed inside the housing for receiving data from the computer;
a memory installed inside the housing for storing data from the computer;
a control module for controlling the image transferring apparatus; and
an outputting module for outputting data to the mobile phone;
a video transferring apparatus for connecting to the mobile phone and the display device comprising:
a receiving module for receiving data from the mobile phone;
a control module for controlling the video transferring apparatus;
a transferring module for transferring data from the receiving module of the video transferring apparatus into a video signal; and
an outputting module for outputting the video signal transferred by the transferring module to the display device.

2. The system of claim 1 wherein the image transferring apparatus further comprises an image capturing module electrically connected to the control module of the image transferring apparatus for capturing an image.

3. The system of claim 2 wherein the image capturing module is a digital camera for capturing digital images to the image transferring apparatus.

4. The system of claim 1 wherein the receiving module of the image transferring apparatus comprises a receiving port for connecting to a transmit port of the computer and transmitting data to the transmit port of the computer.

5. The system of claim 4 wherein the receiving port is an USB interface.

6. The system of claim 1 wherein the outputting module of the image transferring apparatus comprises an outputting port for connecting to a transmit port of the mobile phone and transmitting data to the transmit port of the mobile phone.

7. The system of claim 6 wherein the outputting port is pop-port interface.

8. The system of claim 6 wherein the outputting port is USB OTG interface.

9. The system of claim 1 wherein the outputting module of the image transferring apparatus transmits data to the mobile phone with the Bluetooth wireless network protocol.

10. The system of claim 1 wherein the outputting module of the image transferring apparatus transmits data to the mobile phone by infrared technology.

11. The system of claim 1 wherein the video transferring apparatus further comprises a memory for storing data received by the receiving module of the video transferring apparatus.

12. The system of claim 1 wherein the display device is a television.

13. The system of claim 1 wherein the display device is a monitor.

14. The system of claim 1 wherein the display device is a projector.

15. A method for displaying data with a mobile phone comprising:
(a) providing an image transferring apparatus for receiving data;
(b) transmitting data received by the image transferring apparatus to the mobile phone;
(c) providing a video transferring apparatus for receiving data from the mobile phone and transferring data from the mobile phone to a video signal; and
(d) transmitting the video signal transferred by the video transferring apparatus to a display device and showing the data on the display device.

16. The method of claim 15 wherein in step (a) the image transferring apparatus receives image data from a computer.

17. The method of claim 15 wherein in step (a) the image transferring apparatus receives image data from an image capturing module.

18. The method of claim 15 wherein the display device is a television.

19. The method of claim 15 wherein the display device is a monitor.

20. The method of claim 15 wherein the display device is a projector.

21. The method of claim 15 wherein the image transferring apparatus further comprises:
a receiving module for receiving data;
a memory for storing the receiving data;
a control module for controlling the image transferring apparatus; and
an outputting module for outputting data to the mobile phone;

22. The method of claim 21 wherein the receiving module of the image transferring apparatusis an USB interface.

23. The method of claim 21 wherein the outputting module of the image transferring apparatus is a pop-port interface.

24. The method of claim 21 wherein the outputting module of the image transferring apparatus transmits data to the mobile phone with the Bluetooth wireless network protocol.

25. The method of claim 21 wherein the outputting module of the image transferring apparatus transmits data to the mobile phone by infrared technology.

26. The method of claim 21 wherein the outputting module of the image transferring apparatus is USB OTG interface.

27. The method of claim 15 wherein the video transferring apparatus further comprises:
a receiving module for receiving data from the mobile phone;
a control module for controlling the video transferring apparatus;
a transferring module for transferring data from the receiving module of the video transferring apparatus into a video signal; and
an outputting module for outputting the video signal transferred by the transferring module to the display device.

28. The method of claim 27 wherein the video transferring apparatus further comprises a memory for storing data received by the receiving module of the video transferring apparatus.

29. An image transferring apparatus for connecting to a computer and a mobile phone comprising:
a housing;
a receiving module installed inside the housing for receiving data from the computer;
a memory installed inside the housing for storing data from the computer;
a control module installed inside the housing for controlling the image transferring apparatus; and
an outputting module installed inside the housing for outputting data to the mobile phone.

30. The apparatus of claim 29 further comprising an image capturing module electrically connected to the control module of the image transferring apparatus for capturing an image.

31. The apparatus of claim 30 wherein the image capturing module is a digital camera for capturing digital image to the image transferring apparatus.

32. The apparatus of claim 29 wherein the receiving module of the image transferring apparatus comprises a receiving port for connecting to a transmit port of the computer and transmitting data to the transmit port of the computer.

33. The apparatus of claim 32 wherein the receiving port is USB interface.

34. The apparatus of claim 29 wherein the outputting module of the image transferring apparatus comprises an outputting port for connecting to a transmit port of the mobile phone and transmitting data to the transmit port of the mobile phone.

35. The apparatus of claim 34 wherein the outputting port is a pop-port interface.

36. The apparatus of claim 34 wherein the outputting port is an USB OTG interface.

37. The apparatus of claim 29 wherein the outputting module of the image transferring apparatus transmits data to the mobile phone with the Bluetooth wireless network protocol.

38. The apparatus of claim 29 wherein the outputting module of the image transferring apparatus transmits data to the mobile phone by infrared technology.
